(19) United States
(12) Patent Application Publication
(10) Pub. No.: US 2010/0219975 A1
(43) Pub. Date: Sep. 2, 2010

(54) DIGITAL CARD SYSTEM BASED ON PLACE RECOGNITION FOR SUPPORTING COMMUNICATION

(75) Inventors: Gun Hee Kim, Seoul (KR); Man Chul Han, Seoul (KR); Se Hyung Park, Seoul (KR); Hyun Chul Park, Gwangmyeong-si (KR); Lae Hyun Kim, Seoul (KR); Sung Do Ha, Seoul (KR)

Correspondence Address: Charles N. J. Ruggiero;Ohlandt, Greeley, Ruggiero & Perle, L.L.P., 10th Floor, One Landmark Square, Stamford, CT, 06901-2682, US

(73) Assignee: Korea Institute of Science and Technology

(21) Appl. No.: 12/536,182

(22) Filed: Aug. 5, 2009

(30) Foreign Application Priority Data
Feb. 27, 2009 (KR) 10-2009-0016726

(51) Int. Cl. G09B 21/00

(52) U.S. Cl. 340/825.19

(57) ABSTRACT

A digital card system based on place recognition for supporting communication, which enables people who cannot communicate by the way of speech or writing to communicate by using a digital cards, is provided. Therefore, a user can rapidly and simply search digital cards for communication in response to various situations.

### CROSS-REFERENCE TO RELATED APPLICATIONS

This application claims priority to Korean Patent Application No. 10-2009-0016726, filed on Feb. 27, 2009, and claims all the benefits accruing therefrom under 35 U.S.C. §119. Korean Patent Application No. 10-2009-0016726 is herein incorporated by reference in its entirety.

### BACKGROUND

1. Field

This disclosure relates to a digital card system based on place recognition for supporting communication, and more particularly, to a digital card system based on place recognition for supporting communication, which enables people who cannot communicate by way of speech or writing to communicate by way of digital cards.

2. Description of the Related Art

Augmentative and alternative communication (AAC) is mean of a communication for those who cannot communicate by way of speech or writing and may be any means of access designed to support and improve the communication of those who cannot independently communicate with others in life environments.

The American Speech-Language-Hearing Association (ASHA) defines the augmentative and alternative communication as an area of medical treatment for temporally or permanently complementing for those with language disorders having severe impairments on speaking or writing.

The augmentative and alternative communication encompasses symbols, aids, strategies, and techniques used for the communication of individuals.

Although the words augmentative and alternative are used together in the expression of augmentative and alternative, there is a slight difference between them. Augmentative communication is used for complementing, improving, and supporting communication processes for people having some ability of communication, whereas, in alternative communication, other means of communication is used instead of language.

In general, those with language disorders communicate with others using combinations of simple everyday languages with picture cards as the augmentative and alternative communication means. However, in such a communication method using picture cards, it is inconvenient to carry the picture cards and it is annoying to look for proper cards one by one during the communication.

Therefore, nowadays, in order to solve the problems of the picture card method, communication terminals in which digital cards on which icons representing various expressions are displayed are mounted are developed and distributed.

In the communication method using the digital cards mounted in the communication terminal, various icons and sound files are saved in the communication terminal. So, it is more convenient to carry than the picture cards and it is possible to represent more various expressions than in the previous picture card method.

The communication terminal is an electronic apparatus that involves language therapeutics, special educational technology, and information communication technology. An augmentative and alternative communication program is mounted in the communication terminal to provide convenience to the everyday lives of those with language disorders who cannot normally communicate with others through speaking or writing and to contribute to the self realization of those with language disorders by improving their sociality through language therapy and by developing their communication ability.

With the existing communication method using the digital cards mounted in the communication terminal, more various expressions can be represented than in the communication method using the picture cards. However, in order to look for digital cards related to proper expressions in various situations, a lot of time is required for searching like in the picture card method.

### SUMMARY

In an effort to solve the above-described problems associated with the related art, there is provided a digital card system based on place recognition for supporting communication in which an arrangement priority is given to digital cards using the use frequency of the digital cards used for situations that may occur in a place where a user who owns a communication terminal is located so that the communication terminal may arrange the digital cards based on the priority and display the arranged digital cards.

In one aspect, there is provided a digital card system based on place recognition for supporting communication, including a communication terminal that transmits terminal location information, that includes an augmentative and alternative communication program and digital cards corresponding to expressions, and that outputs the included digital cards to a screen in accordance with a card priority when the included augmentative and alternative communication program is executed, a management server that determines whether the communication terminal enters a service area using the terminal location information transmitted from the communication terminal, that generates card priority information in accordance with use frequencies of the digital cards related with situations occurring in the service area when it is determined that the communication terminal enters the service area, and that transmits the generated card priority information to the communication terminal, and a radio communication network that supports communication between the communication terminal and the management server.

The digital card system may further include a database that stores information on use frequencies of the digital cards related with situations occurring in service areas.

The communication terminal may include a memory module that stores an augmentative and alternative communication program and digital cards corresponding to expressions, wherein the communication program and digital cards are classified under the categories related with situations, a radio communication module that performs radio communication with the management server through the radio communication network, an input module that receives data from a user, a display module that outputs data to a screen, a sound output module that outputs a sound signal, a control module that, when card priority information is received from the management server through the radio communication network and the radio communication module, stores the received card priority information in the memory module, that executes the augmentative and alternative communication program stored in the memory module in accordance with an input of execution of the augmentative and alternative communication program by the user through the input module, that arranges the digital cards stored in the memory module based on the card priority information stored in the memory module to output the digital cards to a screen through the display module, and that, when the user selects one of the digital cards output to the screen through the input module, outputs expressions corresponding to the selected digital card through the display module and the sound output module, and a GPS module that performs GPS communication to generate terminal location information and that transmits the generated terminal location information through the radio communication module.

The control module may output a situation related category selection screen when digital cards are output to a screen through the display module and, as a user selects one of the situation related categories through the input module, may arrange the digital cards corresponding to a selected category based on card priority information stored in the memory module to output the digital cards to a screen through the display module.

When the control module arranges digital cards in accordance with the card priority information to output the digital cards to a screen through the display module, the control module may arrange the digital cards from the left of the screen to the right of the screen in a horizontal direction and from an upper end of the screen to a lower end of the screen in a vertical direction in the order of priority to output the digital cards to the screen through the display module.

The control module outputs a situation related category selection screen when digital cards are output to a screen through the display module and, as a user selects one of the situation related categories through the input module, the control module varies the sizes of the digital cards corresponding to the selected category or the sizes of the icons displayed on the digital cards based on the card priority information stored in the memory module to output the digital cards or the icons to the screen through the display module.

In another aspect, there is provided a digital card system based on place recognition for supporting communication, including a communication terminal that is equipped with an electronic tag, that includes an augmentative and alternative communication program and digital cards corresponding to expressions, and outputs the included digital cards to a screen based on a card priority when the included augmentative and alternative communication program is executed, a tag reader provided in every service area, that reads the electronic tag mounted in the communication terminal and to generate terminal location information of the communication terminal, a management server that receives terminal location information generated by the tag reader to determine whether the communication terminal enters a service area and that, when it is determined that the communication terminal enters the service area, generates card priority information in accordance with use frequencies of the digital cards related with situations occurring in the service area to transmit the generated card priority information to the communication terminal, and a radio communication network that supports communication between the communication terminal and the management server.

The digital card system may further include a database that stores information on the use frequencies of the digital cards related with situations occurring in service areas.

The communication terminal may include a memory module that stores an augmentative and alternative communication program and digital cards corresponding to expressions, wherein the communication program and digital cards are classified under the categories related with situations, a radio communication module that performs radio communication with the management server through the radio communication network, an input module that receives data from a user, a display module that outputs data to a screen, a sound output module that outputs a sound signal, a control module that, when card priority information is received from the management server through the radio communication network and the radio communication module, stores the received card priority information in the memory module, that executes the augmentative and alternative communication program stored in the memory module in accordance with an input of execution of the augmentative and alternative communication program by the user through the input module, that arranges the digital cards stored in the memory module based on the card priority information stored in the memory module to output the digital cards to a screen through the display module, and that, when the user selects one of the digital cards output to the screen through the input module, outputs expressions corresponding to the selected digital card through the display module and the sound output module, and an electronic tag that periodically transmits a beacon signal through the radio communication module.

In the digital card system based on place recognition for supporting communication according this disclosure, an arrangement priority is given to digital cards using the use frequency of the digital cards used for situations that may occur in a place where a user who owns a communication terminal is located, so that the communication terminal may arrange the digital cards based on the priority and display the arranged digital cards. Therefore, the user may rapidly and simply search digital cards for communication in response to various situations.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 schematically illustrates the structure of a digital card system based on place recognition for supporting communication according to an embodiment;

FIG. 2 schematically illustrates the structure of the communication terminal of FIG. 1;

FIG. 3 exemplarily illustrates that digital cards are arranged in the communication terminal in accordance with card priority information to be output to a screen; and

FIG. 4 sequentially illustrates a communication method using the digital card system based on place recognition for supporting communication according to an embodiment.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, a digital card system based on place recognition for supporting communication according to an exemplary embodiment and a communication method using the same will be described in detail with reference to the attached drawings.

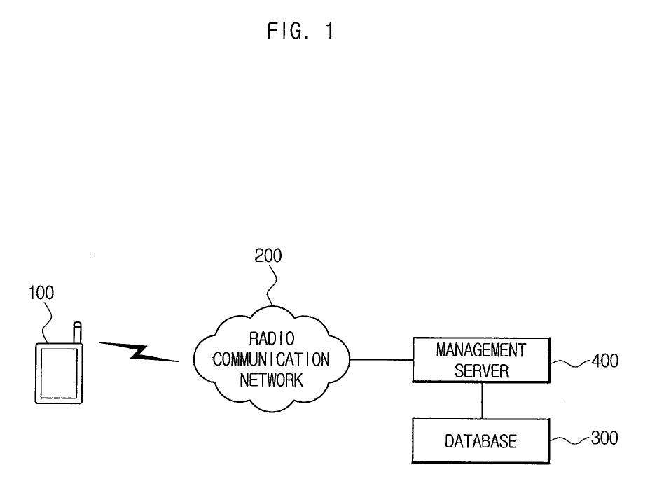

FIG. 1 schematically illustrates the structure of a digital card system based on place recognition for supporting communication according to an embodiment.

Referring to FIG. 1, the digital card system based on place recognition for supporting communication includes a communication terminal 100, a radio communication network 200, a database 300, and a management server 400.

The communication terminal 100 may be, for example, a tablet PC, a mobile telephone, a personal digital assistant (PDA), or a smart phone. The communication terminal 100 periodically generates terminal location information thereof through global positioning system (GPS) communication and transmits the generated information wirelessly. In addition, the communication terminal 100 includes an augmentative and alternative communication program and digital cards corresponding to various expressions and arranges the included digital cards in accordance with the card priority provided by the management server 400 to output the arranged digital cards to a screen when the included augmentative and alternative communication program is executed. Further, the communication terminal 100 performs the expressions corresponding to the digital card selected by a user among the digital cards output to the screen.

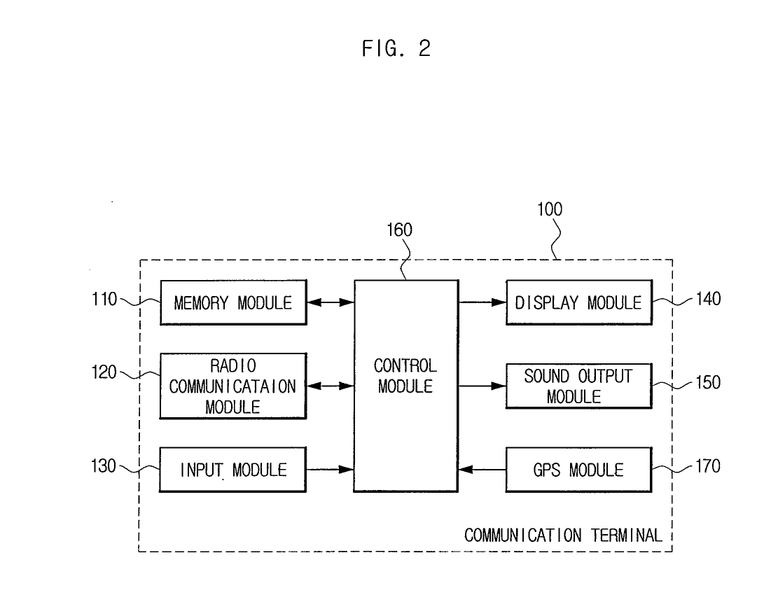

FIG. 2 schematically illustrates the structure of the communication terminal in the digital card system based on place recognition for supporting communication.

Referring to FIG. 2, the communication terminal 100 includes a memory module 110, a radio communication module 120, an input module 130, a display module 140, a sound output module 150, a control module 160, and a GPS module 170.

The memory module 110 stores the augmentative and alternative communication program and the digital cards corresponding to the various expressions, wherein the communication program and digital cards are classified under the categories related with situations.

The radio communication module 120 performs radio communication with the management server 400 through the radio communication network 200.

The input module 130 receives data from the user and transmits the data to the control module 160.

The display module 140 outputs the data to a screen in accordance with the control of the control module 160.

The sound output module 150 outputs a sound signal in accordance with the control of the control module 160.

The control module 160 receives card priority information from the management server 400 through the radio communication network 200 and the radio communication module 120, stores the received card priority information in the memory module 110, and executes the augmentative and alternative communication program stored in the memory module 110 in accordance with the input of the execution of the augmentative and alternative communication program by the user through the input module 130. In addition, the control module 160 outputs the digital cards stored in the memory module 110 to the screen through the display module 140 and, first, outputs a situation related category selection screen. When the user selects one of situation related categories through the input module 130, the control module 160 arranges the digital cards corresponding to the selected category based on the card priority information stored in the memory module 110 to output the digital cards to the screen through the display module 140. In addition, when the user selects one of the digital cards output to the screen through the input module 130, the control module 160 outputs the expression corresponding to the selected digital card through the display module 140 and the sound output module 150.

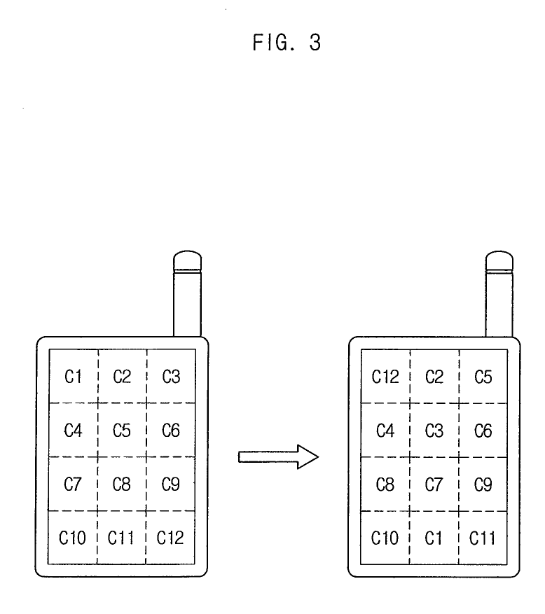

FIG. 3 exemplarily illustrates that digital cards are arranged in the communication terminal in accordance with card priority information to be output to a screen. Referring to FIG. 3, the control module 160 arranges the digital cards, for example, C1, C2, C3, C4, C5, C6, C7, C8, C9, C10, C11, and C12 in accordance with the card priority information to output the digital cards to the screen through the display module 140. For example, the digital cards may be arranged in the order of priority from the left of the screen to the right of the screen in a horizontal direction, and in the order of priority from the upper end of the screen to the lower end of the screen in a vertical direction. That is, the digital cards may be arranged in the order of C12, C2, C5, C4, C3, C6, C8, C7, C9, C10, C1, and C11 and output to the screen through the display module 140.

In addition, for example, when the user selects one of the situation related categories through the input module 130, the control module 160 may vary the sizes of the digital cards corresponding to the selected category based on the card priority information stored in the memory module 110 or the sizes of the icons displayed on the digital cards to output the digital cards or the icons to the screen through the display module 140.

The GPS module 170 performs GPS communication to periodically generate terminal location information and transmits the generated terminal location information through the radio communication module 120.

The radio communication network 200 supports communication between the communication terminal 100 and the management server 400.

The database 300 stores information on the use frequencies of the digital cards related with situations occurring in service areas respectively.

When the management server 400 receives the terminal location information transmitted from the communication terminal 100 through the radio communication network 200, the management server 400 recognizes the place in which the terminal is located using the received terminal location information. In addition, the management server 400 determines whether the communication terminal 100 enters a place in which a specific service is provided, i.e., a service area. When it is determined that the communication terminal 100 enters a service area, the management server 400 searches the use frequencies of the digital cards related with situations occurring in the service area in the database 300. As a result of searching, the management server 400 gives an arrangement priority to each digital card using the use frequencies of the digital cards searched to generate the card priority information. The generated card priority information is transmitted to the communication terminal 100 through the radio communication network 200.

For example, when the communication terminal 100 enters a place where provides a coffee, i.e., a coffee shop, in which order related situation occur, the management server 400 recognizes that the communication terminal 100 enters the coffee shop. Then, the management server 400 gives the arrangement priority to each digital card related with the situation occurring in the coffee shop and then gives higher priorities to the digital cards corresponding to the kind of coffee and the expressions required for ordering coffee.

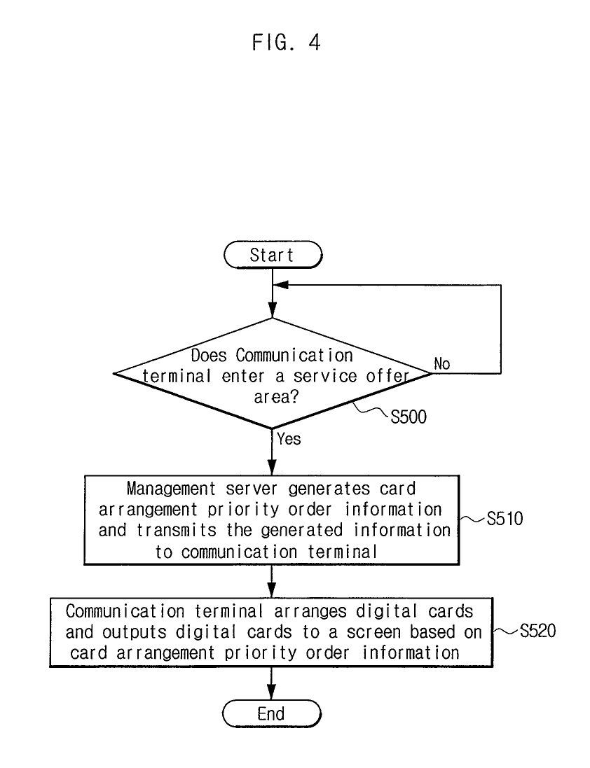

FIG. 4 sequentially illustrates a communication method using the digital card system based on place recognition for supporting communication according to an embodiment. The communication method using the place recognition based digital card system for supporting communication will be described with reference to FIG. 4.

First, the management server 400 periodically recognizes the location of the communication terminal 100 to determine whether the communication terminal 100 enters a service area such as a coffee shop, a restaurant, or a convenience store (S500).

When it is determined in S500 that the communication terminal 100 enters the service area, the management server 400 searches information on the use frequencies of the digital cards related to situations such as an order that may occur in the service area from the database 300. As a result of searching, the management server 400 gives the arrangement priority to each digital card in accordance with the use frequencies of the digital cards searched in the database 300 to generate the card priority information. The generated card priority information is transmitted to the communication terminal 100 through the radio communication network 200 (S510).

For example, when it is determined in S500 that the communication terminal 100 enters a coffee shop, in S510, higher priorities are given to the digital cards corresponding to the kind of coffee and expressions required for ordering coffee.

The communication terminal 100 that received the card priority information from the management server 400 in S510 stores the received card priority information. When the augmentative and alternative communication program is executed in accordance with the input by the user, for the convenience of the user during the searching of the digital cards, various situations related categories are output to the screen. Then, as the user selects one of the categories output to the screen, the digital cards corresponding to the selected category are output to the screen and are arranged based on the card priority information stored therein to output the digital cards to the screen (S520).

In S520, as the user selects one of the categories output to the screen, the communication terminal 100 outputs the digital cards corresponding to the selected category to the screen. For example, the sizes of the digital cards corresponding to the selected category or the sizes of the icons displayed on the digital cards may be varied based on the card priority information stored therein and be output the digital cards and the icons to the screen.

Alternatively, an electronic tag that periodically transmits a beacon signal may be mounted in the communication terminal 100 instead of the GPS module and a tag reader may be provided in every service area. When the communication terminal 100 enters a specific service area, the tag reader provided in the specific service area receives the beacon signal transmitted from the electronic tag mounted in the communication terminal 100 to generate the terminal location information of the communication terminal 100 in which the electronic tag is mounted. When the generated terminal location information of the communication terminal 100 is transmitted to the management server 400, the management server 400 receives the terminal location information from the tag reader and determines whether the communication terminal 100 enters the specific service area using the received terminal location information. Here, the electronic tag periodically transmits the beacon signal through the radio communication module 120 provided in the communication terminal 100 to inform the location thereof to the tag reader.

The communication terminal for supporting communication according to this disclosure may be used for situations under the circumferences where communication cannot be easily performed based on place recognition.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A digital card system based on place recognition for supporting communication, comprising:
a communication terminal that transmits terminal location information, that includes an augmentative and alternative communication program and digital cards corresponding to expressions, and that outputs the included digital cards to a screen in accordance with a card priority when the included augmentative and alternative communication program is executed;
a management server that determines whether the communication terminal enters a service area using the terminal location information transmitted from the communication terminal, that generates card priority information in accordance with use frequencies of the digital cards related with situations occurring in the service area when it is determined that the communication terminal enters the service area, and that transmits the generated card priority information to the communication terminal; and
a radio communication network that supports communication between the communication terminal and the management server.

2. The digital card system according to claim 1, further comprising a database that stores information on the use frequencies of the digital cards related with situations occurring in service areas.

3. The digital card system according to claim 1,
wherein the communication terminal comprises:
a memory module that stores an augmentative and alternative communication program and digital cards corresponding to expressions, wherein the communication program and the digital cards are classified under the categories related with situations;
a radio communication module that performs radio communication with the management server through the radio communication network;
an input module that receives data from a user;
a display module that outputs data to a screen;
a sound output module that outputs a sound signal;
a control module that, when card priority information is received from the management server through the radio communication network and the radio communication module, stores the received card priority information in the memory module, that executes the augmentative and alternative communication program stored in the memory module in accordance with an input of execution of the augmentative and alternative communication program by the user through the input module, that arranges the digital cards stored in the memory module based on the card priority information stored in the memory module to output the digital cards to a screen through the display module, and that, when the user selects one of the digital cards output to the screen through the input module, outputs expressions corresponding to the selected digital card through the display module and the sound output module; and
a GPS module that performs GPS communication to generate terminal location information and that transmits the generated terminal location information through the radio communication module.

4. The digital card system according to claim 3, wherein the control module outputs a situation related category selection screen when digital cards are output to a screen through the display module and, as a user selects one of the situation related categories through the input module, arranges digital cards corresponding to a selected category based on the card priority information stored in the memory module to output the digital cards to a screen through the display module.

5. The digital card system according to claim 4, wherein, when the control module arranges digital cards in accordance with the card priority information to output the digital cards to a screen through the display module, the control module arranges the digital cards from the left of the screen to the right of the screen in a horizontal direction and from an upper end of the screen to a lower end of the screen in a vertical direction in the order of priority to output the digital cards to the screen through the display module.

6. The digital card system according to claim 3, wherein the control module outputs a situation related category selection screen when digital cards are output to a screen through the display module and, as a user selects one of the situation related categories through the input module, the control module varies the sizes of the digital cards corresponding to the selected category or the sizes of the icons displayed on the digital cards based on the card priority information stored in the memory module to output the digital cards or the icons to the screen through the display module.

7. A digital card system based on place recognition for supporting communication, comprising:
a communication terminal that is equipped with an electronic tag, that includes an augmentative and alternative communication program and digital cards corresponding to expressions, and outputs the included digital cards to a screen based on a card priority when the included augmentative and alternative communication program is executed;
a tag reader provided in every service area, that reads the electronic tag mounted in the communication terminal and to generate terminal location information of the communication terminal;
a management server that receives terminal location information generated by the tag reader to determine whether the communication terminal enters a service area and that, when it is determined that the communication terminal enters the service area, generates card priority information in accordance with use frequencies of the digital cards related with situations occurring in the service area to transmit the generated card priority information to the communication terminal; and
a radio communication network that supports communication between the communication terminal and the management server.

8. The digital card system according to claim 7, further comprising a database that stores information on the use frequencies of the digital cards related with situations occurring in service areas.

9. The digital card system according to claim 7,
wherein the communication terminal comprises:
a memory module that stores an augmentative and alternative communication program and digital cards corresponding to expressions, wherein the communication program and the digital cards are classified under the categories related with situations;
a radio communication module that performs radio communication with the management server through the radio communication network;
an input module that receives data from a user;
a display module that outputs data to a screen;
a sound output module that outputs a sound signal;
a control module that, when card priority information is received from the management server through the radio communication network and the radio communication module, stores the received card priority information in the memory module, that executes the augmentative and alternative communication program stored in the memory module in accordance with an input of execution of the augmentative and alternative communication program by the user through the input module, that arranges the digital cards stored in the memory module based on the card priority information stored in the memory module to output the digital cards to a screen through the display module, and that, when the user selects one of the digital cards output to the screen through the input module, outputs expressions corresponding to the selected digital card through the display module and the sound output module; and
an electronic tag that periodically transmits a beacon signal through the radio communication module.
